(19) United States
(12) Patent Application Publication
(10) Pub. No.: US 2024/0154234 A1
(43) Pub. Date: May 9, 2024

(54) Cell holder for holding battery cells, and cell module

(71) Applicant: Webasto SE, Stockdorf (DE)

(72) Inventors: Sebastian Stoll, Stockdorf (DE); Anton Serbak, Stockdorf (DE); Hans Beyer, Stockdorf (DE)

(21) Appl. No.: 18/282,476

(22) PCT Filed: Mar. 21, 2022
(86) PCT No.: PCT/EP2022/057313

§ 371 Date: Sep. 15, 2023

(30) Foreign Application Priority Data
Mar. 19, 2021 (DE) 10 2021 106 892.4
Jul. 27, 2021 (DE) 10 2021 119 484.9

(51) Int. Cl. H01M 50/291; H01M 50/213; H01M 50/505; H01M 50/509

(52) U.S. Cl. CPC H01M 50/291; H01M 50/213; H01M 50/505; H01M 50/509

(57) ABSTRACT

The invention relates to a cell holder for holding cylindrical battery cells, where the cell holder comprises: a plurality of holding portions each of which has a bottom and sidewalls and thus forms a portion that is designed to receive and fix, around a base surface and, at least in part, a lateral surface, one battery cell in each case, where the sidewalls enclose the holding portions in each case; at least one contact surface, which is arranged in a contact region for the battery cell substantially perpendicularly to the bottom and is designed to be in planar or linear contact with a portion of a lateral surface of the battery cell when the battery cell is inserted; and at least one deformable contact portion, which is designed to deform when the battery cell is inserted into the corresponding holding portion.

### CROSS-REFERENCE TO RELATED APPLICATIONS

This application is a 35 U.S.C. § 371 National Stage Entry of International Application No. PCT/EP2022/057313 filed Mar. 21, 2022, which claims the priority benefit of German Patent Application Serial Number DE 10 2021 119 484.9 filed Jul. 27, 2021 and German Patent Application Serial Number DE 10 2021 106 892.4 filed Mar. 19, 2021, all of which are incorporated herein by reference in their entirety for all purposes.

### TECHNICAL FIELD

The present invention relates to a cell holder for holding at least one cylindrical battery cell, preferably for use in a traction battery for electric vehicles or hybrid vehicles or vehicles having fuel cells, as well as a method for manufacturing a cell holder.

### BACKGROUND

Battery systems for electric vehicles, hybrid vehicles, as well as vehicles having fuel cells, form the subject of current research and development. Typically, several cylindrical battery cells are combined to form a battery module, also denoted as a “battery pack”. A traction battery for a vehicle in turn comprises one or more battery modules.

A battery module has cell holders, the objective thereof being to fix the battery cells mechanically and thus to combine them to form a larger unit, the battery module. The cell holders may be made in one piece or multiple pieces from molded parts, or they may be made entirely or partially from casting compound after the initial positioning of the battery cells, for their permanent fixation in the battery housing.

A known design uses honeycombed cell holders, such as described for example in US 2010/0136413 A1. In this case, the battery cells are arranged parallel to each other, upright and offset in rows, so that they form a structure of the densest circular packing, when viewed in cross section relative to the longitudinal extent of the battery cells. The battery cells are held on both sides in the axial direction by one cell holder each, which has cup-shaped recesses corresponding to the battery cells, into which the battery cells are inserted.

FIG. 1 shows in cross section a detail of an exemplary cell holder 1 with cup-shaped holding portions 10, which are formed by a base 11 and side walls 12. The holding portions 10 are arranged such that they receive and fix an axial end of one respective battery cell 2 facing in the directions parallel to the base 11 and toward the base 11. The battery cell 2 stands upright in the installed state, i.e., the axial direction or the cell axis A thereof is located perpendicularly to the base 11. By using two such cell holders 1, each of which fixes one end of the battery cells 2, the battery cells 2 are held in a sandwich-like manner and thus form a cell module or battery module.

It is known to manufacture the cell holders 1 as injection-molded parts from plastics. Such injection-molded cell holders, however, have so-called demolding angles or demolding slopes to be able to be easily demolded from their molding tool. For illustration, the demolding angles α, which are manifested by a tapering of the side walls 12 starting from the base 11 in the axial direction, are illustrated in an exaggerated manner in FIG. 1. After the plastics has hardened, the cell holder 1 is removed from the molding tool (not shown in the figures) in a demolding direction E that is parallel to the cell axis A.

Such manufacturing-related demolding angles counteract a defined and planar contact of the side walls with the battery cells. The battery cells tend to be supported by the side walls only along a linear contour, see the contact regions K in FIG. 1, but not in a planar manner, which impedes an exact positioning and orientation and a secure hold of the battery cells. This also has a disadvantageous effect on the assembly, which may have to be carried out with a not inconsiderable clearance fit. The interface between the battery cells and the cell holder is also sensitive to production tolerances of the cell holder and the battery cells. A holding portion, the side walls thereof circulating entirely around the corresponding battery cell, generally results in an increased installation space, but this is also in particular due to the thickening on the bottom side as a result of the demolding angle.

When arranging the battery cells, care must be taken to maintain sufficient spacing between adjacent battery cells to prevent thermal propagation to adjacent cells, in the event of a so-called “thermal runaway” of a battery cell and to preclude a short circuit. To this end, it is common to arrange the cell holders such that they ensure a sufficient spacing between the battery cells. In this case, the battery cells form a cell pattern, for example square or hexagonal, in which adjacent cells all have the same spacing from one another.

Nevertheless, the probability of a short circuit between adjacent battery cells not only depends on the spacing but also on the connection thereof. Thus, a larger spacing must be maintained between adjacent battery cells that are electrically connected in series than between adjacent battery cells that are electrically connected in parallel. Generally, however, today's cell holders have identical cell spacings, which for safety reasons must meet requirements for the spacing of two battery cells connected in series. If the electrical connection within a battery module is known and unchangeable, this results in a sub-optimal packing density of the battery cells and thus a sub-optimal energy density. If the cell holder is arranged to permit different electrical connection patterns, however, the number of technically feasible configurations is limited so that in these cases most cell spacings are kept unnecessarily large. In addition to the negative effects on energy density, larger cell spacings also result in increased material consumption in the cell holder and a higher weight.

### SUMMARY OF THE INVENTION

One objective of the invention is to provide an improved cell holder for holding at least one cylindrical battery cell and an improved cell module.

The objective is achieved by a cell holder having the features of claim 1, a cell holder having the features of claim 8, and a cell module having the features of claim 13. Advantageous embodiments are found in the dependent claims, the following description of the invention, and the description of preferred embodiments.

The cell holder disclosed herein is preferably for use in a traction battery for electric vehicles or hybrid vehicles or vehicles having fuel cells. A cell module or battery module, generally having a plurality of battery cells, may have one or two cell holders to gather and to hold or to fix the battery cells.

The cell holder according to the invention comprises a plurality of holding portions, each having a base and side walls and thus form a (preferably concave) portion, which is arranged to receive and fix an axial end of each battery cell, i.e., a bottom surface, and at least in some portions the lateral surface of the battery cell. Due to the cylindrical shape of the battery cell, the battery cell defines a cell axis as well as a lateral surface which extends along the cell axis as well as in the peripheral direction of the battery cell. The battery cell is fixed by the cell holder in at least one direction, but preferably in a plurality of directions. Thus, the base and the side walls are preferably arranged to fix the corresponding battery cell in all directions parallel to the base as well as in the direction of the base.

The side walls of the respective holding portions comprise at least one contact surface, which is arranged in a contact region with the battery cell essentially perpendicularly to the base and which is arranged to be in planar or linear contact with a portion of a lateral surface of the battery cell when the battery cell is inserted, and at least one deformable contact portion, which is designed to deform when the battery cell is inserted into the corresponding holding portion. The contact surface preferably does not deform in this case.

In other words, the contact surface, which is curved in a concave manner, coincides with a corresponding portion of the lateral surface of the battery cell, so that it results in a planar contact. The deformable contact portion is located at a different point, preferably opposing the contact surface. The contact portion is preferably elastically deformable so that it acts in the manner of a spring.

The contact surface preferably has a cylindrical or partially cylindrical shape. It should be noted that the terms “cylindrical” and “circular” do not have to define a complete cylindrical circumference or circle in this case, but that the contour of a corresponding segment is encompassed, since the contact surface does not entirely surround the battery cell, but only lies in a planar manner against a partial portion of the battery cell circumference, for example ranging from 20° to 90°.

The cell holder constructed in this way can be manufactured in a resource- and cost-efficient manner, since the geometries of the holding portions with the corresponding side walls can be produced in a simple manner, for example by injection-molding. The holding portions permit an exact positioning and orientation as well as a defined mechanical connection of the battery cell(s) to the cell holder. The assembly of the cell is facilitated by the deformable contact portion. The holding portions also permit a particularly space-saving arrangement of the battery cells directly adjacent to one another since the lateral surface of an inserted battery cell may remain free between the contact regions and does not have to be entirely enclosed by the material of the cell holder. The effects achieved are also comparatively insensitive to production tolerances of the cell holder and the battery cells. Due to the insensitivity relative to fluctuating cell diameters, the cell holder may hold battery cells from different manufacturers without modification, thus saving resources and costs in the event of a possible change of battery cell types/manufacturers.

Preferably, the contact surface is attached to the base, whereby that region of the corresponding holding portion which essentially defines the position and orientation of the battery cell is configured to be particularly stable. The base and the contact surface are preferably formed in one piece.

Preferably, the deformable contact portion is not attached to the base, which allows the deformability to be implemented in a structurally simple manner.

Preferably, the contact surface is curved concavely, in particular circularly, in a cross-section parallel to the base, whereby it interacts optimally with a correspondingly shaped circular-cylindrical battery cell.

Preferably, the contact surface and the deformable contact portion form a non-zero angle when viewed in a cross-section perpendicular to the ground without the battery cell inserted. In this way, it is possible to compensate for tolerances and to improve the fixing of the battery cell. The deformable contact portion thus also functions as an insertion chamfer for a corresponding battery cell.

Preferably, the holding portions in each case comprise a plurality of deformable contact portions, in particular exactly two deformable contact portions, whereby the fixing and correct orientation of the corresponding battery cell is improved, and the holder is stabilized. The features, technical effects and advantages described with respect to the use of a deformable contact portion apply equally to any further deformable contact portions.

Preferably, the side wall of a holding portion carrying the contact surface has a deformable contact portion of an adjacent holding portion. In other words, the contact surface as well as the one or more deformable contact portions of an adjacent holding portion are preferably configured in one piece and by exactly one structural part. In this manner, adjacent holding portions are structurally integrated with one another, whereby the cell holder may be configured in a particularly compact manner.

Preferably, the cell holder is manufactured from plastics, in particular in an injection-molding method. Preferably, the cell holder is configured in one piece. The cell holder according to one of the variants set forth above is particularly suitable as an injection-molded part since the structural nature thereof and the manufacturing method cooperate synergistically, as is clear from the description of the method.

The above-mentioned objective is also achieved by a cell holder for holding cylindrical battery cells, preferably for use in a traction battery for electric vehicles or hybrid vehicles or vehicles having fuel cells, wherein the cell holder comprises: a plurality of holding portions, each having a base as well as side walls and thus each forming a portion which is arranged to receive and fix a bottom surface and, at least in some portions, a lateral surface of one respective battery cell; wherein the holding portions are arranged such that battery cells inserted therein have, at least in part, different spacings from their adjacent neighbors.

The cell holder may have one or more of the features defined above. The described technical effects, advantages, and embodiments thus apply equally to the cell holder defined above.

When measuring the spacing, the shortest spacing is used between the lateral surfaces of the corresponding adjacent battery cells in a cutting plane perpendicular to the cell axes. It should also be mentioned that the holding portions clearly predetermine the position and orientation of the battery cells, so that in the inserted state the battery cells, in particular the above-defined spacings thereof, imply a structural definition of the holding portions. A fully occupied cell holder is assumed for determining the spacing of adjacent battery cells, so that variable spacings due to unoccupied holding portions are excluded.

Since the cell holder is constructed such that the holding portions thereof permit variable spacings between the inserted battery cells, the packing density of the battery cells may be optimized in comparison with an equidistant cell positioning, without losses in terms of safety. This results in a lower material consumption, low costs and a lower weight of the cell holder.

Preferably a plurality of holding portions, for example three holding portions, are combined to form one respective cell group, whereby the advantage of a high packing density is combined with achieving flexibility relative to the electrical connection.

Preferably, adjacent cell groups are separated from one another by means of a group wall, whereby the electrical insulation and/or mechanical safety is increased. The cell groups are thus preferably separated from one another by stabilizing webs or group walls. No such group walls are located inside the cell groups. A larger or smaller number of holding portions may be combined to form a cell group, depending on the application, the material of the cell holder, the requirement for stability, and the like. Such a combination in turn results in a saving of material and space, whereby the cell modules constructed from the battery cells, as well as one or two of the cell holders shown therein, may be configured to be particularly compact.

Preferably, the holding portions are arranged such that the spacing of adjacent battery cells within a cell group is smaller than the spacing of adjacent battery cells of adjacent cell groups.

From a purely electrical point of view, in an extreme case, a cell module may comprise an entire battery group (=logical cell, group of battery cells connected in parallel) to obtain a maximum packing density. For mechanical reasons, however, such a battery group is preferably subdivided into a plurality of cell groups with corresponding cell walls, which also permits flexibility relative to possible electrical connections, without having to change the construction or the design of the cell holder therefor. Compared to a conventional design, a higher packing density is still achieved with lower material consumption, while achieving flexibility with regard to the electrical connection and safety.

Preferably, the holding portions are arranged in rows, wherein the holding portions of adjacent rows are particularly preferably arranged in an offset manner, such as offset by the dimension of half a holding portion. In this manner, a honeycombed structure or a structure of the densest circular packing may be created, viewed in a cross section parallel to the base. In this manner, the number of the battery cells accommodated per surface unit may be maximized.

For the same reason, one or more of the holding portions are preferably configured such that the side walls thereof do not entirely encompass the lateral surface of a correspondingly inserted battery cell with material. The grouping of the holding portions described above can be provided or at least assisted thereby.

Preferably, the holding portions of one respective cell group are in a row, i.e., the cell groups in this case do not span a plurality of rows, whereby a good compromise is achieved between the flexibility of the electrical connection and mechanical stability.

The objective mentioned above is also achieved by a cell module, preferably for use in a traction battery for electric vehicles or hybrid vehicles or vehicles having fuel cells, wherein the cell module comprises: at least one cell holder according to one of the variants described above; a plurality of battery cells, each of which is inserted into a holding portion of the cell holder and fixed thereby; and a connection portion which electrically connects together the battery cells. Preferably, the cell module has two cell holders that hold the battery cells in a sandwich-like manner.

The features, technical effects, advantages, and embodiments that have been described with respect to the cell holders also apply to the cell module equipped therewith.

Preferably, the connection portion is arranged such that battery cells within a cell group are connected in parallel, while battery cells of different cell groups are connected in series, whereby the electrical and mechanical safety are ensured in spite of the high packing density.

Battery cells connected in parallel define a battery group in the cell module. The battery groups present in the cell module are preferably of the same size, i.e., they comprise the same number of battery cells. Preferably, the number of battery cells in a battery group may be divided by the number of holding portions for each cell group, whereby the advantage of a high packing density is combined with achieving flexibility with regard to the electrical connection.

According to one specific embodiment, for example, the cell module comprises total of 297 cell positions, oriented in 11 rows and 27 columns, wherein three battery cells are combined in rows to form one respective cell group. This construction permits a plurality of connection configurations. Thus, the battery cells may be connected in rows in parallel, and the rows may be connected in series. This connection is referred to as the “basic connection” and abbreviated as “11s27p”, wherein in s-p nomenclature “s” represents series and “p” represents parallel. The basic connection is a preferred configuration in terms of busbar geometry and uniform power distribution. However, taking into account the safety aspect that serial connection of closely spaced battery cells should be avoided, the grouping of the battery cells permits further connection patterns or configurations.

A cell module preferably comprises a plurality of cylindrical battery cells and two cell holders to hold the battery cells on either side in the direction of the cell axis by one cell holder each.

The objective mentioned above is also achieved by a method for manufacturing a cell holder, preferably for use in a traction battery for electric vehicles or hybrid vehicles or vehicles having fuel cells, wherein the cell holder is arranged to hold at least one cylindrical battery cell which defines a cell axis. According to the method, the cell holder is injection molded from a plastic material by using a molding tool, which preferably has two tool halves. In the case of the use of a plurality of tool parts/tool halves, these tool parts/tool halves may be displaced, pivoted or moved in a different manner relative to one another to open the tool. In any case, the cell holder may be removed from the molding tool after the plastics has sufficiently hardened in the molding tool.

According to the invention, the cell holder is removed in a demolding direction from the molding tool, wherein the demolding direction and the cell axis are not parallel.

Since the demolding direction and the cell axis are not parallel, the contact between the battery cell and the cell holder may be improved, since the conventional demolding angles required for the injection-molding do not result in any losses in terms of quality but may be used directly for stabilizing the battery cell(s).

This technical effect is achieved, in particular, with a cell holder according to the above description. The features, technical effects, advantages, and embodiments which have been described with respect to the cell holder apply equally to the method.

Further advantages and features of the present invention may be found in the following description of preferred embodiments. The features described therein may be implemented individually or in combination with one or more of the features set forth above, provided the features do not contradict one another. The following description of preferred embodiments is made with reference to the accompanying drawings.

### BRIEF DESCRIPTION OF THE FIGURES

Preferred further embodiments of the invention are explained in more detail by the following description of the figures. In the figures:

FIG. 1 shows a detail of a conventional cell holder, shown in a cross section parallel to the cell axis, with demolding angles shown in an exaggerated manner and a demolding direction parallel to the cell axes;

FIG. 2 shows a plan view of a cell holder with a plurality of holding portions arranged in rows offset relative to each other;

FIG. 3 shows a detail of a cell holder shown in a cross section parallel to the cell axis, the demolding direction thereof is not parallel to the cell axis;

FIG. 4 shows a perspective detail of a cell holder, wherein a free holding portion and a holding portion occupied by a battery cell are shown;

FIG. 5 shows a perspective detail of a holding portion of a cell holder viewed obliquely into the holding portion;

FIG. 6 shows a view from below of a holding portion of a cell holder with an inserted battery cell;

FIG. 7 shows a perspective detail of a cell holder according to a further embodiment;

FIG. 8 shows a perspective detail of the cell holder viewed from a different perspective;

FIG. 9 shows a plan view of the cell holder;

FIG. 10 shows a schematic qualitative view of a grouping of battery cells with different spacings;

FIG. 11 shows a perspective exploded view of a cell module in a basic connection; and

FIGS. 12a, 12b and 12c show schematic views of alternative connections.

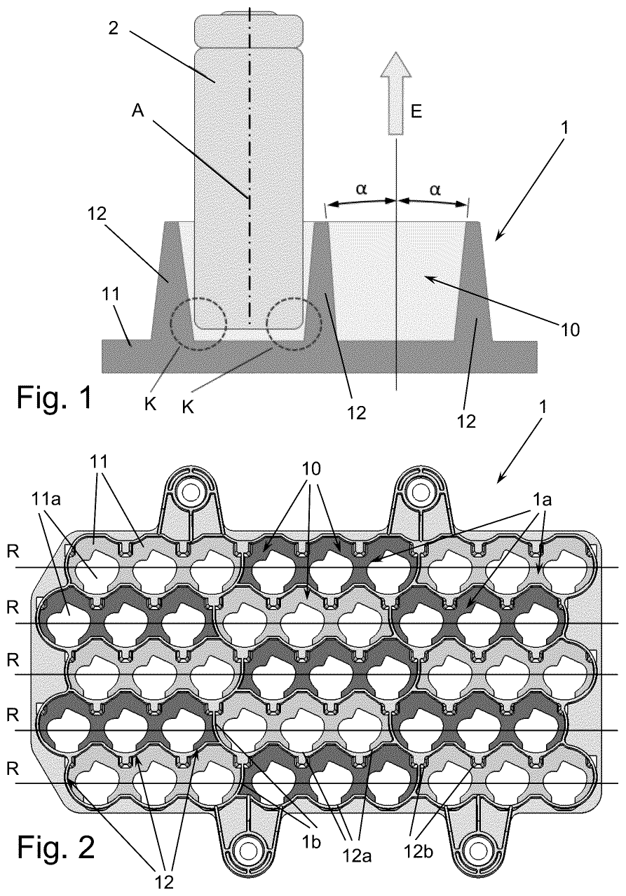

### DETAILED DESCRIPTION OF PREFERRED EMBODIMENTS

Preferred embodiments are described hereinafter with reference to the figures. Elements which are the same, similar or similar-acting are provided in the figures with identical reference signs and a repeated description of these elements is omitted in some cases in order to avoid redundancy.

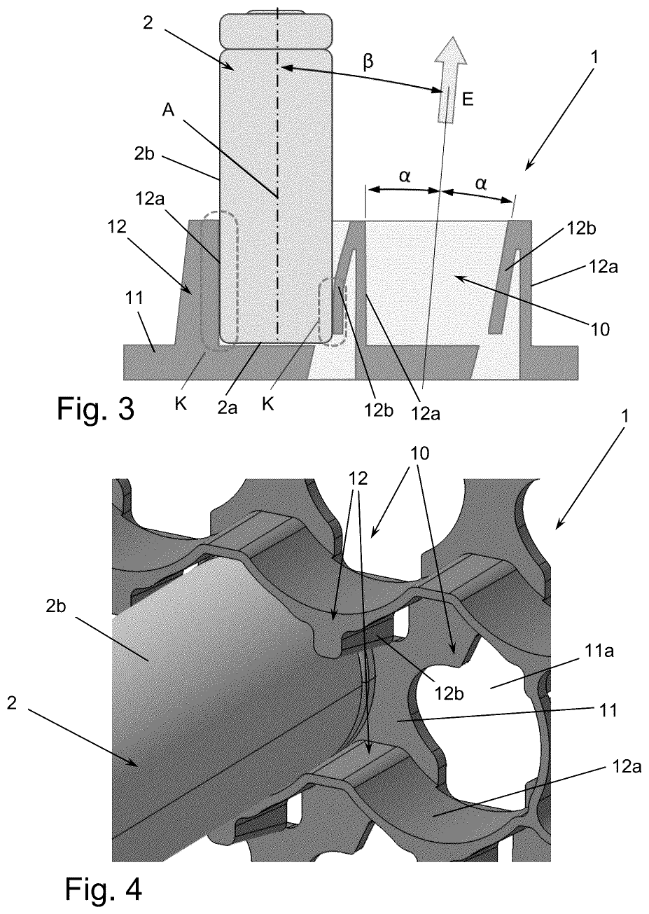

FIG. 2 is a plan view of a cell holder 1 with a plurality of holding portions 10, which are arranged to receive cylindrical battery cells 2, see FIGS. 3, 4 and 6. The cell holder 1 is preferably produced from a plastics, in particular by an injection-molding method. The cell holder 1 is preferably also configured in one piece or substantially in one piece.

The holding portions 10 form concave portions, i.e., they are configured to be cup-shaped or as recesses, so that one of the two axial ends of a battery cell 2 may be inserted into such a holding portion 10, as is revealed particularly clearly from FIGS. 3 and 4.

The holding portions 10 in the present embodiment are arranged in rows R, wherein adjacent rows R are offset by the dimension of half a holding portion 10, resulting in a honeycombed structure or a structure of the densest circular packing. In this manner, the number of battery cells 2 accommodated per surface unit can be maximized. However, the holding portions 10 may also be arranged in a different manner, for example without offsetting adjacent rows R.

The holding portions 10 comprise a base 11 which, when the battery cell 2 is inserted, is in contact with at least one part of the corresponding bottom surface 2a of the battery cell 2, and in this manner axially fixes the battery cell 2, i.e. along the cell axis A (see FIG. 3). It should be mentioned that the bottom surfaces 2a of the battery cells 2 do not have to form perfect planes but may have curvatures, deformations and the like in the axial direction A of the battery cell 2, as is indicated for example in FIG. 6.

The base 11 preferably has a base opening 11a which may be a generous aperture to permit or to facilitate an electrical contact of the battery cells 2.

The holding portions 10 also comprise side walls 12, which are arranged to fix the battery cells 2 in the inserted state in the lateral direction, i.e., perpendicular to the cell axis A. The side walls 12 have a particular structure which improves the hold of the battery cells 2. Such an improvement of the interface between the holding portion 10 and battery cell 2 may be implemented by utilizing manufacturing-dependent demolding angles α, see FIG. 3.

With reference to FIG. 3, the direction in which the cell holder 1, provided it is produced as an injection-molded part, is removed from the corresponding molding tool (not shown in the FIGS. might be denoted as the demolding direction E. According to the present embodiment, the demolding direction E and the cell axis A form a non-zero angle β which, in the case of vertical battery cells 2, coincides with the demolding angle α. In other words, the demolding direction E and the cell axis A are not parallel. Since the demolding direction E and the cell axis A are not parallel, the contact between the battery cell 2 and the side walls 12 of the corresponding holding portion 10 can be improved, as is explained in more detail below.

According to the present embodiment, the side walls 12 of a holding portion 10 comprise a contact surface 12a which stands substantially perpendicularly to the base 11, may be attached to the base 11 and is curved in a concave, in particular cylindrical, manner perpendicularly thereto, such that it coincides with a corresponding portion of the lateral surface 2b of the battery cell 2 and thus is in planar contact with the battery cell 2. Preferably, the cylindrical contact surface 12a is curved in a circular manner perpendicular to the cell axis A to cooperate optimally with circular cylindrical battery cells 2.

The terms “cylindrical” and “circular” do not necessarily define here a complete cylinder circumference or circle. Rather, the contour of a corresponding partial portion, i.e., segment, is encompassed, since the cylindrical contact surface does not entirely surround the battery cell, but bears in a planar manner only against a partial portion of the battery cell circumference, for example in the range from 20° to 90°.

The side walls 12 also comprise one or more, preferably exactly two, deformable contact portions 12b for one respective holding portion 10. The deformable contact portions 12b are at least partially deformed when the battery cell 2 is inserted, in contrast to the contact surface 12a, as is revealed particularly clearly from FIG. 3. The contact portions 12b are preferably elastic, thus in the manner of a spring, and to this end are preferably not attached or not entirely attached to the base 11. The deformable contact portions 12b may create a planar contact or a linear contact with the lateral surface 2b of the battery cell 2 in the axial direction.

In the unoccupied state, i.e., without a battery cell 2 inserted, the contact surface 12a and a corresponding contact portion 12b preferably form a non-zero angle 2α, see FIG. 3, wherein α denotes the demolding angle mentioned above. The demolding angle α defines a taper of the holding portion 10 starting from the base 11 in the demolding direction E, which the one hand, simplifies the removal of the cell holder 1 from a corresponding injection-molding tool and, on the other hand, effects a reliable clamping of a battery cell 2 to be inserted due to the deformability of the contact portions 12b. Due to the vertical contact surface 12a, a precise positioning and orientation of the battery cell 2 is ensured at the same time.

In the present embodiment, the side walls 12 for one respective holding portion 10 have a vertical contact surface 12a and two opposing contact portions 12b This results in three contact points per battery cell 2, wherein at least the contact surface 12a produces a planar contact. The contact portions 12b preferably run obliquely, when viewed relative to the cell axis A, so that they function as insertion chamfers for a corresponding battery cell 2. The contact portions 12b are deformed during the assembly of the cell. The contact portions may be manufactured with conventional demolding slopes and merely from two tool halves by injection-molding.

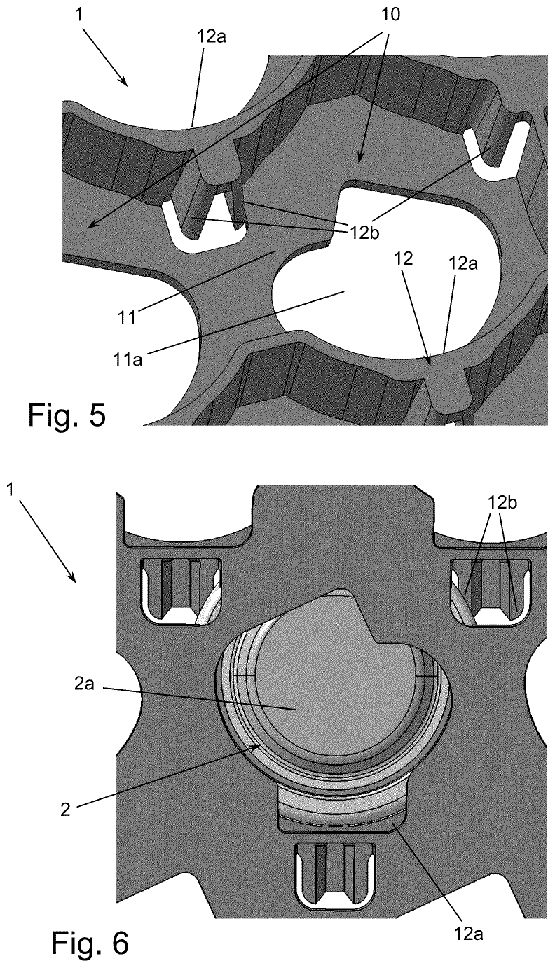

The contact surfaces 12a and deformable contact portions 12b may be structurally integrated with each other, as is revealed particularly clearly from FIGS. 4 and 5. The side wall 12 of a holding portion 10 bearing the contact surface 12a may form at the same time a contact portion 12b of an adjacent holding portion 10. Thus, the contact portion 12b of the holding portion 10 of a specific row R is located, for example, at the height of the apex of the contact surface 12a of an adjacent holding portion of the row R−1, see also FIG. 3.

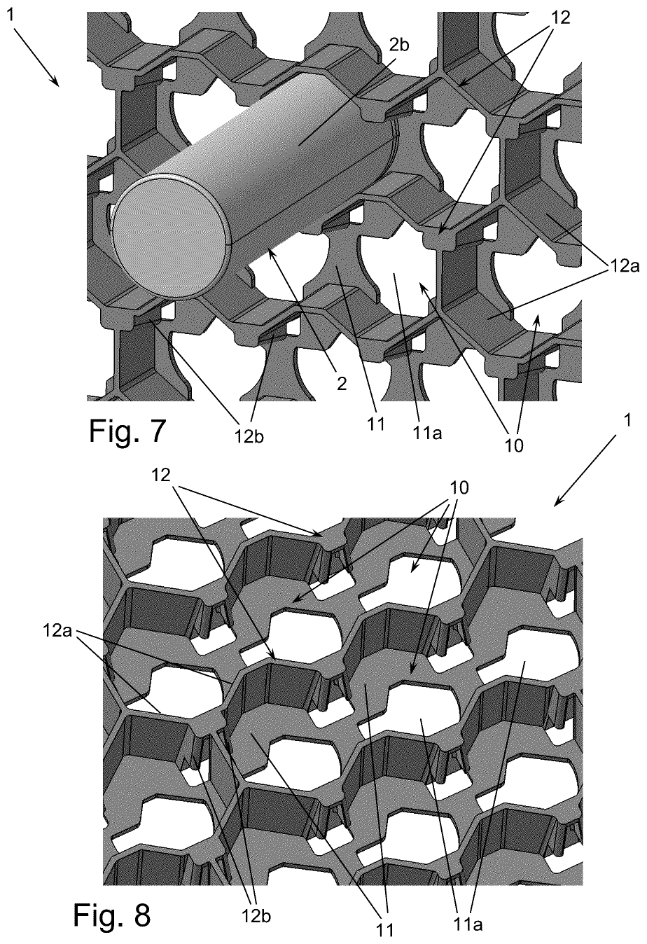

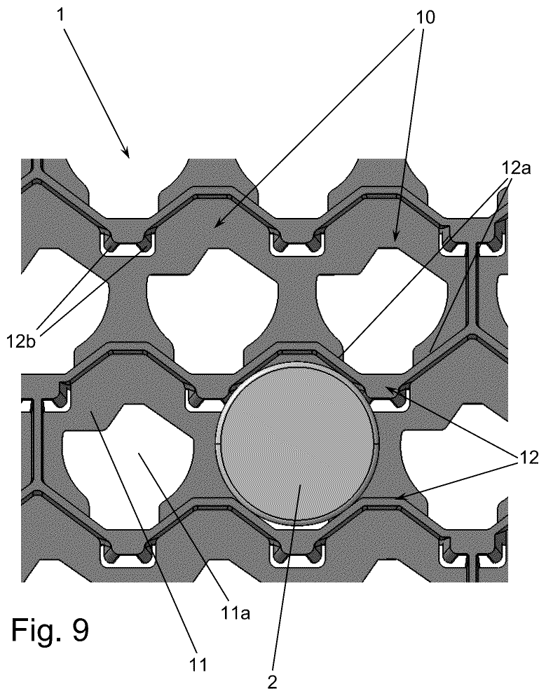

FIGS. 7 to 9 show a further embodiment that differs in the structure of the contact surface 12a from the previous embodiments. While the contact surface 12a according to the embodiment of FIGS. 2, 4, and 5 is cylindrically curved (viewed in a cross section parallel to the base 11) to produce a planar contact with the lateral surface 2b of the battery cell 2, according to the present embodiment the contact surface 12a and the lateral surface 2b of the battery cell 2 substantially form a linear contact at two points, as is revealed particularly clearly from FIG. 9. The contact surface 12a accordingly does not have to correspond to the curvature of the battery cell 2 but may, for example, run in a rectilinear or polygonal manner, when viewed in a cross section perpendicular to the base 11. In this manner, the cell holder 1 may be used in a particularly flexible manner for battery cells 2 of different shapes and/or dimensions.

The subdivision of the side walls 12 into a contact surface 12a and one or more deformable contact portions 12b has the result that between these contact regions the lateral surface 2b of an inserted battery cell 2 may remain free and does not have to be entirely encompassed by the material of the cell holder 1 up to 360°.

As a result, cell groups 1a consisting of immediately adjacent battery cells 2 may be provided. In FIG. 2 cell groups 1a consisting of three respective holding portions 10 are shown by way of example. The cell groups 1a are separated from each other by stabilizing webs or group walls 1b in the direction of the rows R. A larger or smaller number of holding portions 10 may be combined to form a cell group 1a depending on the use, the material of the cell holder 1, the requirement for stability, and the like. Such a combination in turn provides a saving in terms of material and space, whereby the cell modules 100 constructed from the battery cells 2 and one or two of the cell holders 1, shown therein, may be configured in a particularly compact manner (see FIG. 11).

The battery cells 2 of a cell group 1a are preferably electrically connected in parallel, since the lateral surfaces 2b of the battery cells 2 carry the same electrical potential and are also likely to be in contact.

The cell holder 1 is manufactured efficiently in terms of resources and costs, since the geometries of the holding portions with the corresponding sides walls 12 may be injection-molded in a simple manner, for example by means of corresponding molding tool halves. The holding portions 10 permit an exact positioning and a defined mechanical attachment of the battery cells 2 to the cell holder 1. The assembly of the cell is facilitated by insertion chamfers formed by the deformable contact portion 12b. The cell holder 1 permits a uniform component wall thickness to be maintained, which is advantageous for manufacturability and the fire protection classification to be achieved. The holding portions 10 permit an arrangement of the battery cells 2 directly adjacent to one another, which saves installation space. The achieved effects are also relatively insensitive to production tolerances of the cell holder 1 and the battery cells 2. Due to the insensitivity relative to fluctuating cell diameters, the cell holder 1 is able to hold battery cells 2 from different manufacturers without modification, whereby resources and costs can be saved if the battery cell type/manufacturer is potentially changed.

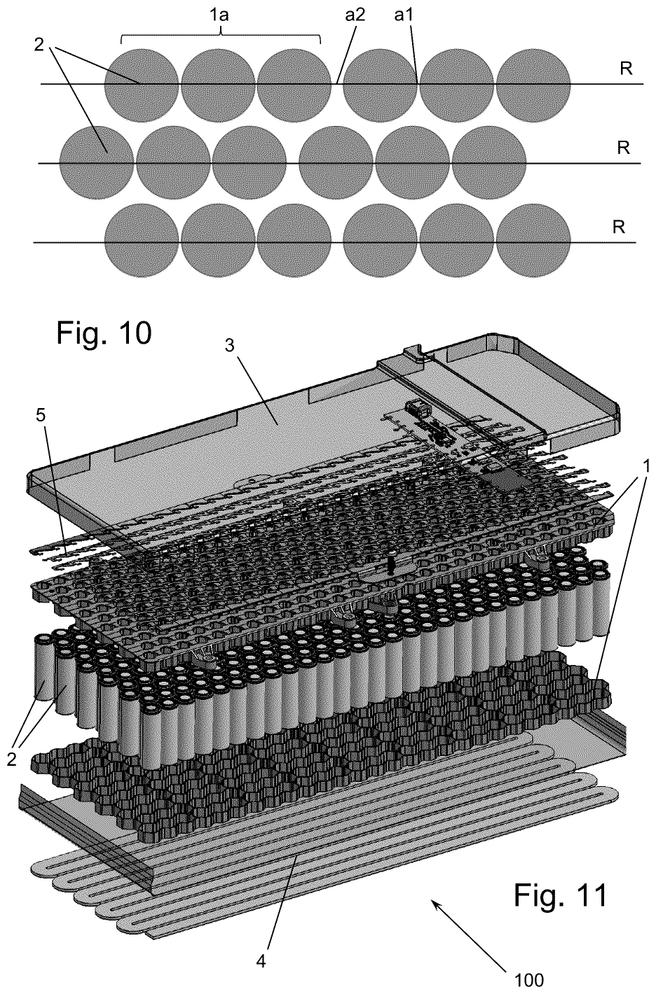

Returning to the grouping of battery cells 2 described with reference to FIG. 2, the grouping may be implemented by different spacings between adjacent battery cells 2 within a cell group 1a and adjacent battery cells 2 of adjacent cell groups 1a. This is shown schematically in FIG. 10, wherein a1 denotes the cell spacing within a group, i.e., the spacing of adjacent battery cells 2 within a cell group 1a, and a2 denotes the cell spacing in groups, i.e., the spacing of adjacent battery cells 2 of adjacent cell groups 1a. In each case, the smallest spacing is used between the lateral surfaces 2b of the corresponding battery cells 2.

The triple grouping according to FIGS. 2 and 10 is only by way of example and a larger or smaller number of battery cells 2 may also be combined to form one respective cell group 1a. If the grouping is implemented by different spacings a1, a2, in the portions of larger spacings a2 the cell holder 1 does not necessarily have to have webs or group walls 1b, even though this is a preferred embodiment according to FIG. 2.

Particularly preferably, units of battery cells 2 of small spacings a1 are connected in parallel, i.e., battery cells 2 within a cell group 1a, while battery cells 2 of different cell groups 1a in this case are connected in series. In this manner, a greater packing density is achieved relative to equidistant cell positioning, without losses in terms of safety.

FIG. 11 shows a cell module 100 with two cell holders 1 and battery cells 2 held in a sandwich-like manner therebetween. A housing portion 3, cooling portion 4 and a connection portion 5 are also shown.

In the embodiment of FIG. 11, the cell module 100 comprises a total of 297 cell positions, orientated in 11 rows R and 27 columns, wherein three battery cells 2 are combined in rows to form one respective cell group 1a. The battery cells 2 are also connected in rows in parallel and the rows R are connected in series. This connection might be denoted as a “basic connection” and abbreviated to “11s27p”, wherein in s-p nomenclature “s” represents in series and “p” represents in parallel. The basic connection is a preferred configuration in terms of busbar geometry, shown by the connection portion 5 of FIG. 11, and uniform power distribution.

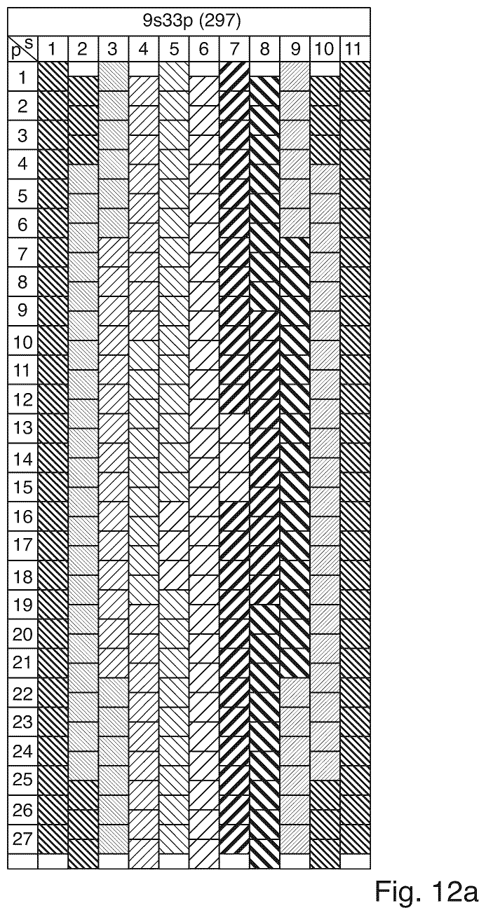

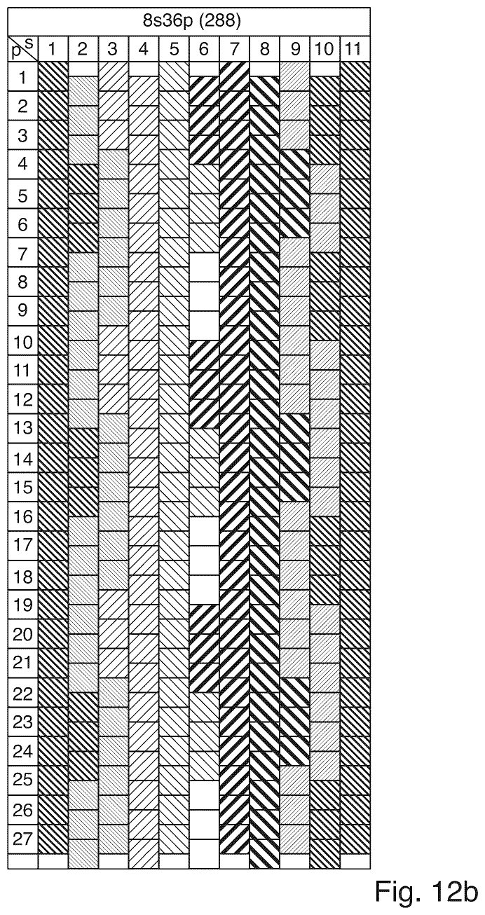

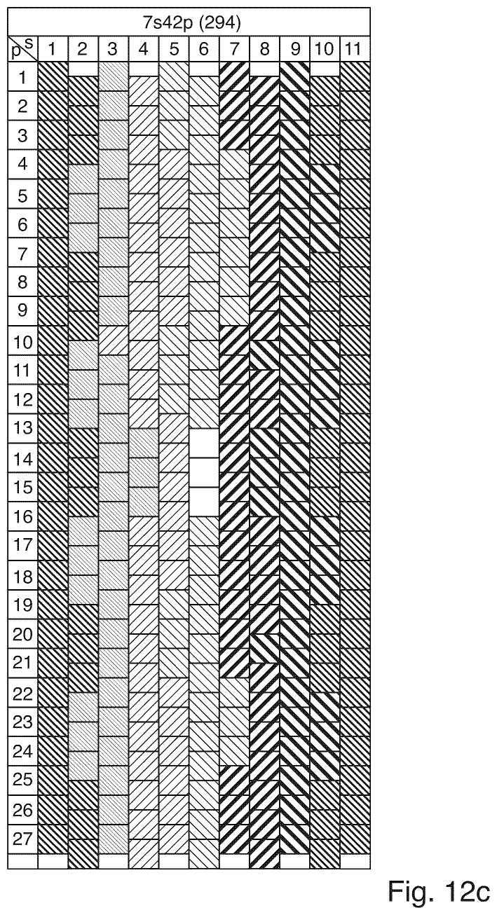

However, the grouping of the battery cells 2 permits further connection patterns or configurations, while taking into account the safety aspect that a series connection of battery cells 2 with a small spacing a1 is to be avoided. FIGS. 12a to 12c show exemplary configurations which may be reasonably represented in terms of busbar geometry and power distribution. Here fields of the same gray scale identify battery cells 2 connected in parallel, while fields of different gray scales form units connected in series. The number in parenthesis after the s-p nomenclature denotes the number of positions actually occupied by battery cells in the cell module 100, where fields marked by “u” (FIGS. 12b and 12c) are unoccupied. The configurations according to FIGS. 11, 12a, 12b, 12c are not complete but further variants are also conceivable.

Additionally, the number and configuration of useful connection patterns vary depending on the number of battery cells 2 combined to form cell groups 1a. From a purely electrical point of view, in an extreme case, in order to obtain a maximum packing density a cell module 100 may comprise an entire battery group (=logical cell, group of battery cells 2 connected in parallel). For mechanical reasons, however, such a battery group is generally subdivided into a plurality of cell groups 1a, which also permits flexibility with regard to possible electrical connections, without having to change the construction or the design of the cell holder 1 therefor. Relative to a conventional design, a greater packing density is still achieved with lower material consumption, while achieving flexibility with regard to the electrical connection and safety.

Preferably, the connection portion 5 is arranged such that possible differences between adjacent battery cells, i.e., series connections, occur only along partition walls, in particular group walls 1b.

The use of different spacings a1, a2 between the battery cells 2, in particular the grouping of battery cells 2 by using group walls 1b, enables the packing density to be optimized in comparison with the equidistant cell positioning without losses in terms of safety. This results in a lower material consumption, low costs, and a lower weight of the cell holder 1. If the number of holding portions 10 per cell group 1a is a divisor of the number of battery cells 2 in a battery group, i.e., a group of battery cells 2 connected in parallel, the advantage of a high packing density is combined with achieving flexibility with regard to the electrical connection.

If applicable, all of the individual features shown in the embodiments may be combined together and/or exchanged without departing from the scope of the invention.

### LIST OF REFERENCE SIGNS

1 Cell holder
1a Cell group
1b Group wall
2 Battery cell
2a Bottom surface
2b Lateral surface
3 Housing portion
4 Cooling portion
5 Connection portion
10 Holding portion
11 Base
11a Base opening
12 Side wall
12a Contact surface
12b Deformable contact portion
100 Cell module
A Cell axis/axial direction
E Demolding direction
K Contact region
R Row
α Demolding angle
β Angle
a1 Cell spacing within a group
a2 Cell spacing in groups

1. A cell holder for holding cylindrical battery cells, wherein the cell holder comprises:
a plurality of holding portions each having a base and side walls, thus each forming a portion which is arranged to receive and fix a bottom surface and, at least in portions, a lateral surface of one respective battery cell; wherein
the side walls of the respective holding portions comprise: at least one contact surface which is arranged in a contact region with the battery cell substantially perpendicularly to the base and which is arranged to be in planar or linear contact with a portion of a lateral surface of the battery cell when the battery cell is inserted, and at least one deformable contact portion which is arranged to deform when the battery cell is inserted into the corresponding holding portion.

2. The cell holder as claimed in claim 1, wherein at least one of: the contact surface is attached to the base; the deformable contact portion is not, or not entirely, attached to the base; and the contact surface is concavely curved in a cross section parallel to the base.

3. The cell holder as claimed in claim 1, wherein the contact surface has at least one of: a cylindrical and a partially cylindrical shape.

4. The cell holder as claimed in claim 3, wherein, without the battery cell inserted, the contact surface and the deformable contact portion form a non-zero angle.

5. The cell holder as claimed in claim 4, wherein the holding portions each comprise exactly two deformable contact portions.

6. The cell holder as claimed in claim 5, wherein the side wall of a holding portion carrying the contact surface has a deformable contact portion of an adjacent holding portion.

7. The cell holder as claimed in claim 6, wherein one or more of the holding portions are configured such that the side walls thereof do not entirely encompass the lateral surface of a corresponding inserted battery cell with material.

8. A cell holder for holding cylindrical battery cells, wherein the cell holder comprises:
a plurality of holding portions each having a base and side walls, thus each forming a portion which is arranged to receive and fix a bottom surface and, at least in portions, a lateral surface of one respective battery cell; wherein
the holding portions are arranged such that battery cells inserted therein have at least partially different spacings from their immediately adjacent neighbor.

9. The cell holder as claimed in claim 8, wherein a plurality of holding portions, preferably three thereof, are combined to form one respective cell group.

10. The cell holder as claimed in claim 9, wherein the holding portions are arranged such that the spacing of adjacent battery cells within a cell group is smaller than the spacing of adjacent battery cells of adjacent cell groups.

11. The cell holder as claimed in claim 10, wherein the holding portions are arranged in rows, wherein the holding portions of adjacent rows are arranged to be offset.

12. The cell holder as claimed in claim 11, wherein the holding portions for one respective cell group are in a row.

13. A cell module, wherein the cell module comprises:
at least one cell holder;
a plurality of battery cells each inserted into a holding portion of the cell holder and fixed thereby; and
a connection portion which electrically connects the battery cells.

14. The cell module as claimed in claim 13, wherein the connection portion is arranged such that battery cells are connected in parallel within a cell group, while battery cells of different cell groups are connected in series.

15. The cell module as claimed in claim 14, wherein battery cells which are connected in parallel in the cell module each define a battery group, and the number of battery cells in a battery group can be divided by the number of holding portions for each cell group.

16. The cell holder as claimed in claim 3, wherein the cylindrical contact surface is circularly curved in a cross section parallel to the base.

17. The cell holder as claimed in claim 9, wherein the plurality of holding portions comprise three holding portions.

18. The cell holder as claimed in claim 9, wherein adjacent cell groups are delimited from one another by means of a group wall.

19. The cell holder as claimed in claim 11, wherein the holding portions of adjacent rows are arranged to be offset by the dimension of half a holding portion.
